(19) United States
(12) Patent Application Publication
(10) Pub. No.: US 2025/0132088 A1
(43) Pub. Date: Apr. 24, 2025

(54) TUNABLE INDUCTOR AND METHODS TO REALIZE TUNABLE INDUCTOR

(71) Applicant: Hamilton Sundstrand Corporation, Charlotte, NC (US)

(72) Inventors: Bo Liu, Milford, CT (US); Parikshith Channegowda, Marlborough, CT (US)

(21) Appl. No.: 18/490,574

(22) Filed: Oct. 19, 2023

(51) Int. Cl. H01F 29/02; H01F 3/14; H01F 17/04

(52) U.S. Cl. CPC H01F 29/025; H01F 3/14; H01F 17/04

(57) ABSTRACT

A tunable inductor is provided including a core having a closed shape and including first through third legs. A first winding wound around the first leg is coupled to a first controller configured to provide DC power to the first winding. The first winding is configured to generate a DC flux in a DC flux path in response to the DC power, the DC flux path passing through a first magnetoelectric material coupled to the core. A second winding wound around the second leg is coupled to the first controller and is configured to generate the DC flux in response to the DC power. A third leg between the first leg and the second leg is coupled to an AC power source configured to provide AC power to the third winding. The third winding is configured to generate AC flux in an AC flux path based on the AC power.

### BACKGROUND

The present disclosure relates to inductors and, in particular, to the realization of tunable inductors.

Inductors are passive components that can be critical to power handling in power converter topologies such as, for example, DC-DC conversion, AC-DC conversion, and the like. Though some tunable inductors have been implemented in a wide variety of applications, the basic mechanism of achieving tunability of some inductors is associated with several disadvantages.

### BRIEF DESCRIPTION

According to an aspect of the disclosure, a tunable inductor is provided including: a core having a closed shape and including a first leg, a second leg, and a third leg between the first leg and the second leg; a first winding wound around the first leg; a second winding wound around the second leg; a third winding wound around the third leg; and a first magnetoelectric material coupled to the core. The first winding is coupled to a first controller configured to provide DC power to the first winding, and the first winding is configured to generate a DC flux in a DC flux path in response to the DC power, the DC flux path passing through the first magnetoelectric material. The second winding is coupled to the first controller and is configured to generate the DC flux in response to the DC power. The third winding is coupled to an AC power source configured to provide AC power to the third winding, and the third winding is configured to generate AC flux in an AC flux path in response to the AC power, the AC flux path passing through the first magnetoelectric material.

In some embodiments, the first magnetoelectric material may be coupled to a portion of the core that is not wound by the first winding, the second winding, or the third winding.

In any one or combination of the embodiments disclosed herein, the portion of the core may include: an upper portion of the core, where the upper portion is between the first leg and the second leg; or a lower portion of the core, where the lower portion is between the first leg and the second leg.

In any one or combination of the embodiments disclosed herein, the tunable inductor may further include: a second magnetoelectric material coupled to the core, where: the DC flux path further may pass through the second magnetoelectric material; the AC flux path may further pass through the second magnetoelectric material; and the second magnetoelectric material may be coupled to a portion of the core that is not wound by the first winding, the second winding, or the third winding.

In any one or combination of the embodiments disclosed herein, the DC flux path may pass through the first leg, the second leg, the third leg, the first magnetoelectric material, and the second magnetoelectric material; the AC flux path may pass through the third leg, the first magnetoelectric material, and the first leg in a counterclockwise direction; and the AC flux path may pass through the third leg, the second magnetoelectric material, and the second leg in a clockwise direction.

In any one or combination of the embodiments disclosed herein, the tunable inductor may further include: a second controller configured to control one or more properties of the first magnetoelectric material, where the second controller is configured to control the one or more properties based on at least one of: a reluctance of a first branch of the tunable inductor, the first branch including the first leg, the third leg, and a first upper portion between the first leg and the third leg; and a second reluctance of a second branch of the tunable inductor, the second branch including the second leg, the third leg, and a second upper portion between the second leg and the third leg.

In any one or combination of the embodiments disclosed herein, the tunable inductor may be absent an air gap.

According to an aspect of the disclosure, a tunable inductor is provided including: a core having a closed shape and including a first leg, a second leg, and a third leg between the first leg and the second leg; a first winding wound around the first leg; and a second winding wound around the second leg, where a first winding direction of an upper half of the second winding is opposite to a second winding direction of a lower half of the second winding. The first winding is coupled to a controller configured to provide DC power to the first winding, and the first winding is configured to generate a DC flux in a DC flux path in response to the DC power, the DC flux path passing through the first leg, the third leg, and the second leg. The second winding is coupled to an AC power source configured to provide AC power to the second winding, and the second winding is configured to generate AC flux in a plurality of AC flux paths in response to the AC power. A first AC flux path of the plurality of AC flux paths passes through an upper portion of the core and returns via a path perpendicular to the third leg, and a second AC flux path of the plurality of AC flux paths passes through a lower portion of the core and returns via a second path perpendicular to the third leg.

In any one or combination of the embodiments disclosed herein, the tunable inductor may further include: a first magnetoelectric material coupled to a portion of the core that is not wound by the first winding or the second winding, where the DC flux path may pass through the first magnetoelectric material, and the first AC flux path may pass through the first magnetoelectric material.

In any one or combination of the embodiments disclosed herein, the portion of the core may include: the upper portion of the core, where the upper portion is between the first leg and the second leg; or the lower portion of the core, where the lower portion is between the first leg and the second leg.

In any one or combination of the embodiments disclosed herein, the tunable inductor may further include: a second magnetoelectric material coupled to a second portion of the core that is not wound by the first winding or the second winding, where the DC flux path further may pass through the second magnetoelectric material and the first AC flux path or the second AC flux path may pass through the second magnetoelectric material.

In any one or combination of the embodiments disclosed herein, a first distance between the first leg and the third leg may be less than a second distance between the second leg and the third leg.

In any one or combination of the embodiments disclosed herein, the tunable inductor may further include: a controller configured to control one or more properties of one or more magnetoelectric materials coupled to portion of the core that is not wound by the first winding or the second winding, where the controller is configured to control the one or more properties based on one or more target properties of the tunable inductor.

In any one or combination of the embodiments disclosed herein, the tunable inductor may be absent an air gap.

According to an aspect of the disclosure, a tunable inductor is provided including: a core having a closed shape and including a first leg and a second leg; a first winding wound around the first leg; and a second winding wound around the second leg, where a first winding direction of an upper half of the second winding is opposite to a second winding direction of a lower half of the second winding.

The first winding is coupled to a controller configured to provide DC power to the first winding, and the first winding is configured to generate a DC flux in a DC flux path in response to the DC power, the DC flux path passing through the first leg and the second leg. The second winding is coupled to an AC power source configured to provide AC power to the second winding, and the second winding is configured to generate AC flux in a plurality of AC flux paths in response to the AC power. A first AC flux path of the plurality of AC flux paths passes through an upper leg of the core and returns via a path perpendicular or almost perpendicular to the first leg and the second leg. A second AC flux path of the plurality of AC flux paths passes through a lower leg of the core and returns via a second path perpendicular or almost perpendicular to the first leg and the second leg.

In any one or combination of the embodiments disclosed herein, the tunable inductor may further include a first magnetoelectric material coupled to a portion of the core that is not wound by the first winding or the second winding, where the DC flux path may pass through the first magnetoelectric material, and the first AC flux path may pass through the first magnetoelectric material.

In any one or combination of the embodiments disclosed herein, the portion of the core may include an upper portion of the core, where the upper portion is between the first leg and the second leg, or a lower portion of the core, where the lower portion is between the first leg and the second leg.

In any one or combination of the embodiments disclosed herein, the tunable inductor may further include a second magnetoelectric material coupled to a second portion of the core that is not wound by the first winding or the second winding, where the DC flux path further may pass through the second magnetoelectric material, and the first AC flux path or the second AC flux path may pass through the second magnetoelectric material.

In any one or combination of the embodiments disclosed herein, the tunable inductor may further include a controller configured to control one or more properties of one or more magnetoelectric materials coupled to portion of the core that is not wound by the first winding or the second winding, where the controller is configured to control the one or more properties based on one or more target properties of the tunable inductor.

In any one or combination of the embodiments disclosed herein, the tunable inductor may be absent an air gap.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an example of a tunable inductor in accordance with one or more embodiments of the present disclosure.

FIG. 2 is an example of a tunable inductor in accordance with one or more embodiments of the present disclosure.

FIG. 3 is an example of a tunable inductor in accordance with one or more embodiments of the present disclosure.

FIG. 4 is an example of a tunable inductor in accordance with one or more embodiments of the present disclosure.

FIG. 5 is an example of a tunable inductor in accordance with one or more embodiments of the present disclosure.

FIG. 6 is an example of a tunable inductor in accordance with one or more embodiments of the present disclosure.

FIG. 7 is an example of a tunable inductor in accordance with one or more embodiments of the present disclosure.

FIGS. 8A and 8B are plots of example characteristics of some other tunable inductors.

### DETAILED DESCRIPTION

A detailed description of one or more embodiments of the disclosed apparatus and method are presented herein by way of exemplification and not limitation with reference to the Figures.

Some techniques have implemented tunable inductance in a wide variety of applications, with both electrical and mechanical methods of achieving inductor tunability. However, the basic mechanism of achieving tunability of some inductors is associated with several disadvantages.

For example, an inductor having a tunable inductance may be associated with an increase in physical inductor size and an unbalanced flux distribution in the core material associated with the inductor. Other disadvantages associated with some tunable inductors include high back-electromotive force (EMF) voltages induced in the control coil and associated power supply, and further, high ripple current spikes may be induced on the control side. Other example disadvantages associated with some tunable inductors include a relatively narrow range of tunability and a relatively slow control of the inductor characteristics.

According to one or more embodiments of the present disclosure, hybrid approaches are described that support the realization of a tunable inductor.

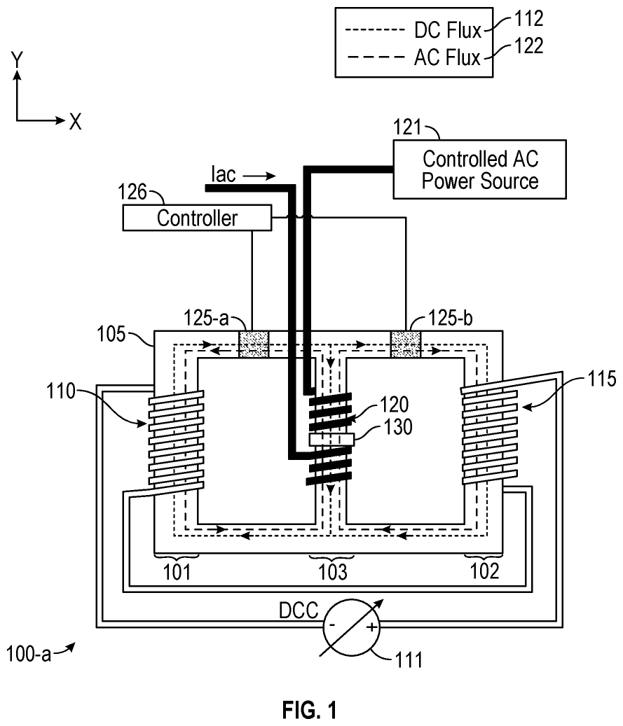

FIG. 1 is an example of a tunable inductor 100-a in accordance with one or more embodiments of the present disclosure. The tunable inductor 100-a includes a core 105. The tunable inductor 100-a may be referred to as a ‘soft’ tunable inductor 100, and the core 105 may be referred to as a ‘soft’ magnetic core, in that the core 105 is formed of material having soft magnetic properties. For example, the core 105 may be magnetized in response to voltages across windings (e.g., first winding 110, second winding 115, and/or third winding 120) of the tunable inductor 100-a.

The core 105 may include a saturable material. Aspects of the present disclosure support different core geometries and structures of the core 105, and the core 105 may be made of one or more magnetizing materials such as, for example, steel, iron, ferrous alloy(s), nickel iron, or other saturable materials. Different cross-sections of the core 105 may have different saturation levels due to flux flow, use of saturable materials, and other factors.

In the example of FIG. 1, the core 105 is a quadrilateral shaped, but aspects of the tunable inductor 100-a are not limited thereto. The core 105 may be an enclosed core of any suitable shape (e.g., a closed shape, quadrilateral, rectangular, square, circular, or the like) or dimension supportive of the techniques of inductor tuning as described herein. Aspects of the present disclosure support the implementation of one or more types of cross-sectional shapes and geometries such as, for example, substantially rectangular, circular, or oval shapes.

The core 105 includes a first leg 101, a second leg 102, and a third leg 103 between the first leg 101 and the second leg 102. In the example of FIG. 1, the first leg 101, the second leg 102, and the third leg 103 are parallel to one another, but aspects of the core 105 are not limited thereto.

The tunable inductor 100-a includes a first winding 110 wound around the first leg 101 and a second winding 115 wound around the second leg 102. The first winding 110 and the second winding 115 are coupled to a first controller 111. The first controller 111 may be, for example, a direct current (DC) controller capable of providing DC power to the first winding 110 and the second winding 115. In response to the DC power, the first winding 110 and the second winding 115 generate a DC flux 112 (also referred to herein as a magnetic flux or magnetic field resulting from the DC power provided to the first winding 110 and/or the second winding 115), and the DC flux 112 flows through the core 105 according to a DC flux path (indicated by arrows) illustrated at FIG. 1. The first winding 110 and second winding 115 may also be referred to herein as DC coils.

The tunable inductor 100-a includes a third winding 120 wound around the third leg 103. In an example, the third winding 120 is coupled to an AC power source 121 providing AC power to the third winding 120. In response to the AC power, the third winding 120 generates AC flux 122 (also referred to herein as a magnetic flux or magnetic field resulting from the AC power provided to the third winding 120), and the AC flux 122 flows through the core 105 according to an AC flux path (indicated by arrows) illustrated at FIG. 1. The third winding 120 may also be referred to as an AC coil.

According to example aspects of the present disclosure, the techniques described herein incorporate magnetoelectric materials 125 at the tunable inductor 100, and the magnetoelectric materials 125 have an adjustable permeability supportive of balancing the flux in the various paths of the core 105. In the example of FIG. 1, the tunable inductor 100-a includes a first magnetoelectric material 125-a and a second magnetoelectric material 125-b coupled to the core 105.

The first magnetoelectric material 125-a and the second magnetoelectric material 125-b may be coupled to portions of the core 105 that are not wound by the first winding 110, the second winding 115, or the third winding 120. In the example of FIG. 1, the first magnetoelectric material 125-a is coupled to an upper portion of the core 105, between the first leg 101 and the third leg 103, and the second magnetoelectric material 125-b is coupled to an upper portion of the core 105, between the second leg 102 and the third leg 103.

Aspects of the tunable inductor 100-a are not limited thereto, and the first magnetoelectric material 125-a and the second magnetoelectric material 125-b may be coupled to any suitable location on the core 105 such that the AC flux path and DC flux paths described herein pass through the first magnetoelectric material 125-a and second magnetoelectric material 125-b. For example, the first magnetoelectric material 125-a may be coupled to the upper portion or a lower portion of the core 105, between the first leg 101 and the third leg 103, and the second magnetoelectric material 125-b may be coupled to the upper portion or a lower portion of the core 105, between the second leg 102 and the third leg 103.

As illustrated at in the example of FIG. 1, the AC flux path and DC flux paths pass through the first magnetoelectric material 125-a and the second magnetoelectric material 125-b. In the example of FIG. 1, the DC flux path passes through the first leg 101, the second leg 102, the third leg 103, the first magnetoelectric material 125-a, and the second magnetoelectric material 125-b. Also in the example of FIG. 1, the AC flux path passes through the third leg 103, the first magnetoelectric material 125-a, and the first leg 101 in a counterclockwise direction, and the AC flux path passes through the third leg 103, the second magnetoelectric material 125-b, and the second leg 102 in a clockwise direction.

According to example aspects of the present disclosure, the tunable inductor 100-a may include or be coupled to a second controller 126 (also referred to herein as a tuning circuit) configured to control one or more properties of the first magnetoelectric material 125-a and the second magnetoelectric material 125-b. For example, the second controller 126 may generate a control signal associated with controlling properties (e.g., permeability) of the first magnetoelectric material 125-a and/or second magnetoelectric material 125-b, which in turn impacts one or more properties of the tunable inductor 100. For example, the control signal may be a control voltage which, when applied by the second controller 126 to a magnetoelectric material 125 (e.g., first magnetoelectric material 125-a, second magnetoelectric material 125-b), establishes an induced internal magnetic field at the magnetoelectric material 125.

In an example, the second controller 126 may control the properties based on a first reluctance R of a first branch of the tunable inductor 100-a and/or a second reluctance R of a second branch of the tunable inductor 100. In an example, the first branch includes the first magnetoelectric material 125-a (e.g., a branch including the first leg 101, the third leg 103, and a first upper portion of the core 105 between the first leg 101 and the third leg 103), and the second branch includes the second magnetoelectric material 125-b (e.g., a branch including the second leg 102, the third leg 103, and a second upper portion of the core 105 between the second leg 102 and the third leg 103).

Accordingly, for example, as the magnetoelectric materials 125 have properties of adjustable permeability with applied electric field, by placing the magnetoelectric materials 125 in each magnetic flux path of the tunable inductor 100-a (e.g., in the magnetic flux paths of the magnetic core 105) and controlling the electric field in segments of the tunable inductor 100-a associated with the magnetoelectric materials 125, the techniques described herein support manipulation of the magnetic flux (e.g., the amplitude of the magnetic flux) in each magnetic flux path. The implementation of the magnetoelectric materials 125 and control of the properties of the magnetoelectric materials 125 support an increased number of capabilities in tunable inductors.

For example, the example tunable inductor 100-a and the techniques described herein support controlled rebalancing of uneven AC flux distribution through the balancing the reluctance R of branches (e.g., two branches) of the tunable inductor 100-a via the first magnetoelectric material 125-a and second magnetoelectric material 125-b when applying a voltage to tune permeability. Tuning the permeability of the first magnetoelectric material 125-a and/or second magnetoelectric material 125-b cancels the induced back-EMF AC voltage (associated with the AC flux and the third winding 120) on the first winding 110 and second winding 115.

In an example, balancing the reluctance R of branches of the tunable inductor 100-a (and thereby, balancing uneven AC flux distribution) may be implemented by applying a voltage at the first magnetoelectric material 125-a and/or the second magnetoelectric material 125-b to tune the rated voltage and magnetic permeability (μᵣ) of the tunable inductor 100. The tuning may effectively cancel the induced back-EMF AC voltage (also referred to herein as uncancelled high back-EMF voltage) and high ripple current on the first winding 110, the second winding 115, and the control path associated with the tunable inductor 100.

For example, the total reluctance of the tunable inductor 100-a may be expressed by the following Equation:

$${R}_{eq} = \sum \frac{l}{{μ}_{r} A}$$

The second controller 126 may include sensing circuitry ((not illustrated) capable of sensing the AC voltages of the first winding 110 and second winding 115 or the magnetic flux of the two branches (e.g., AC flux 122) described herein. In an example, the sensed difference of the two AC winding voltages (e.g., the AC voltages of the first winding 110 and second winding 115) or the difference of the magnetic fluxes (e.g., AC flux 122) of the two branches may be connected to a closed-loop feedback controller such as, for example, a proportional-integral-derivative (PID) controller, a proportional-resonant (PR) controller, or a combination of the PID controller and the PR controller. The closed-loop feedback controller may be configured to adaptively tune the output voltage of the second controller 126 for rebalancing the reluctance R and AC flux of the branches of the tunable inductor 100-a. The AC voltage sensing described herein supports indirect sensing of the AC voltages of the first winding 110 and the second winding 115, as the AC voltage of each winding is proportional to the AC flux flowing through the corresponding branch of the tunable inductor 100-a.

As described herein in accordance with aspects of the present disclosure, the principles described herein in association with the controlled permeability of the magnetoelectric materials 125 (and thereby, for example, the controlled rebalancing of uneven AC flux distribution and controlled balancing of reluctance R) at the tunable inductor 100-a may support implementations capable of omitting the air gap 130 in the third leg 103. For example, the example principles and techniques described herein support implementations of tunable inductors which may omit a center leg of EE shaped cores and eliminate the center leg in gapless cores, examples of which are later described herein.

Further, for example, the example dimensions, shapes, and quantities of the magnetoelectric materials 125 provided herein are not limited to the example embodiments described herein. For example, the magnetoelectric materials 125 may be of any suitable shape, size, and quantity of instances supportive of the techniques for the controlled permeability of the magnetoelectric materials 125, the controlled rebalancing of uneven AC flux distribution, and the controlled balancing of reluctance R at the tunable inductor 100-a as described herein.

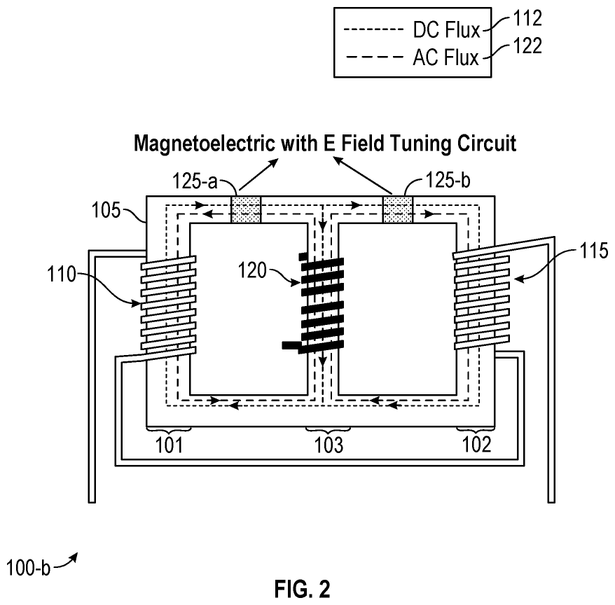

FIG. 2 is an example of a tunable inductor 100-b in accordance with one or more embodiments of the present disclosure. The tunable inductor 100-b includes aspects of tunable inductor 100-a, and repeated descriptions of like elements are omitted for brevity. Further, so as not to distract from the additional and/or alternative features described in FIG. 2, aspects of the first controller 111, AC power source 121, and second controller 126 (of FIG. 1) are not illustrated.

According to one or more embodiments of the present disclosure, in addition to the effects of flux balancing as described herein, the use of the magnetoelectric materials 125 supports implementations of a tunable inductor 100-b in which the air gap 130 (of FIG. 1) in the third leg 103 may be omitted.

In some aspects, through the omission of the air gap 130 (of FIG. 1), the tunable inductor 100-b supports a reduction in leakage flux, eddy current loss, and electromagnetic noise that could otherwise be introduced at the air gap 130.

According to one or more embodiments of the present disclosure, the example aspects described herein may be applied to other magnetic winding structures for tunable inductor implementation.

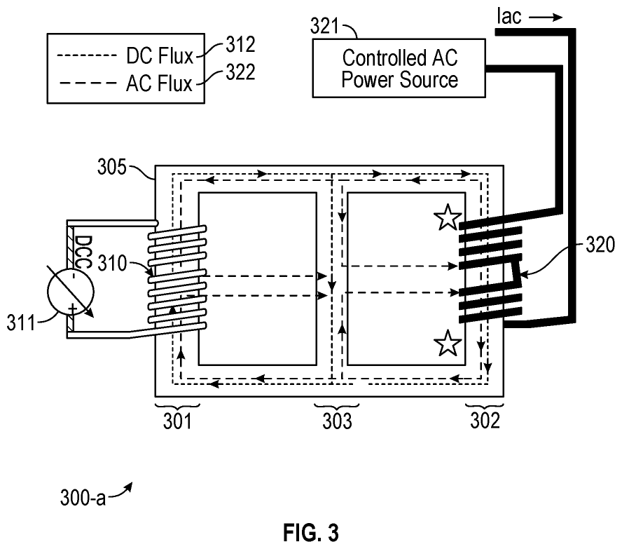

FIG. 3 is an example of a tunable inductor 300-a in accordance with one or more embodiments of the present disclosure. The tunable inductor 300-a may include aspects of other example tunable inductors (e.g., tunable inductor 100-a, tunable inductor 100-b) described herein, and repeated descriptions of like elements are omitted for brevity.

According to one or more embodiments of the present disclosure, the tunable inductor 300-a illustrates an example implementation of reversely wound windings supportive of eliminating an air gap in tunable inductors (e.g., implementation of a gapless tunable inductor). The example configuration and features of the tunable inductor 300-a described herein support adjustment of magnetic flux in the tunable inductor 300-a and implementation without an air gap (e.g., an air gap 130 as in FIG. 1).

Referring to the example of FIG. 3, tunable inductor 300-a includes a core 305. The core 305 includes a first leg 301, a second leg 302, and a third leg 303 between the first leg 301 and the second leg 302.

The tunable inductor 300-a includes a first winding 310 wound around the first leg 301. In an example, the first winding 310 is coupled to a controller 311 providing DC power to the first winding 310. In an example, the first winding 310 generates a DC flux 312 in a DC flux path in response to the DC power, and the DC flux path (indicated by arrows) passing through the first leg 301, the third leg 303, and the second leg 302.

The tunable inductor 300-a includes a second winding 320 wound around the second leg 302. In one or more embodiments, a winding direction of the first winding 310 is opposite a second winding direction of the second winding 320. In an example, the second winding 320 is coupled to an AC power source 321 providing AC power to the second winding 320.

The second winding 320 generates AC flux 322 in a plurality of AC flux paths (indicated by arrows) in response to the AC power. In an example, a first AC flux path of the plurality of AC flux paths may pass through an upper portion of the core 305 (e.g., in a direction toward the first winding 310) and returns via a path perpendicular to the third leg 303. In another example, a second AC flux path of the plurality of AC flux paths may pass through a lower portion of the core 305 and returns via a second path through the air perpendicular (e.g., substantially or almost perpendicular) to the third leg 303. In some examples, other AC flux paths of the plurality of AC flux paths may pass through part or the entirety of the upper portion or the lower portion and return via a path through the air perpendicular (e.g., substantially or almost perpendicular) to the third leg 303. In an example, the return path may be substantially parallel to a horizontal axis (e.g., the X-axis in FIG. 3) of the tunable inductor 300-a.

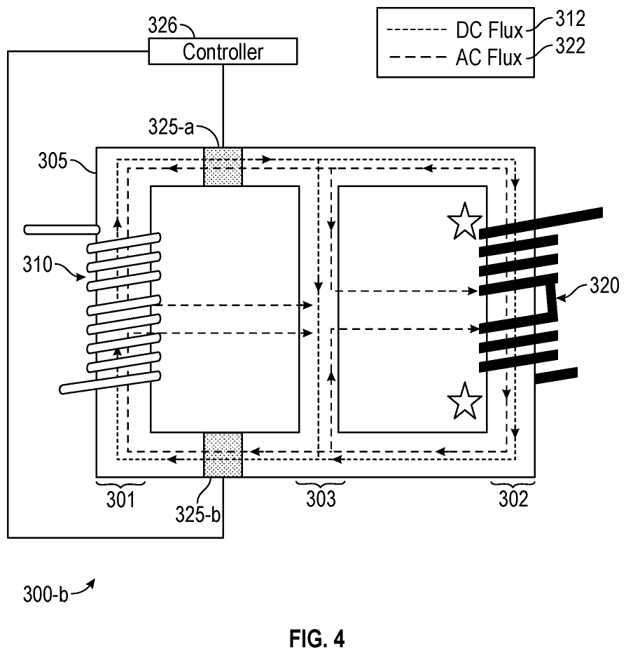

FIG. 4 is an example of a tunable inductor 300-b in accordance with one or more embodiments of the present disclosure. The tunable inductor 300-b includes aspects of tunable inductor 300-a, and repeated descriptions of like elements are omitted for brevity. Further, so as not to distract from the additional and/or alternative features described in FIG. 3, aspects of the first controller 311 and AC power source 321 (of FIG. 3) are not illustrated.

According to one or more embodiments of the present disclosure, the tunable inductor 300-b may include one or more magnetoelectric materials 325 to further balance magnetic flux (e.g., DC flux 312, AC flux 322). According to example aspects of the present disclosure, the magnetoelectric materials 325 have an adjustable permeability supportive of balancing the flux in the various paths of the core 305. In the example of FIG. 4, the tunable inductor 300-b includes a first magnetoelectric material 325-a and a second magnetoelectric material 325-b coupled to the core 305.

The tunable inductor 300-b includes a second controller 326 configured to control one or more properties of magnetoelectric materials 325. The second controller 326 may control the properties based on one or more target properties of the tunable inductor 300. In an example, each of the first magnetoelectric material 325-a and the second magnetoelectric material 325-b is coupled to a portion of the core 305 that is not wound by the first winding 310 or the second winding 320.

In the example of FIG. 4, the first magnetoelectric material 325-a is coupled to an upper portion of the core 305, between the first leg 301 and the second leg 302, and the second magnetoelectric material 325-b is coupled to a lower portion of the core 305, between the first leg 301 and the second leg 302. Similarly, as described with reference to FIG. 1, by inserting and controlling the magnetoelectric materials 325, the techniques described herein support rebalancing of the unbalanced AC flux and reluctance R.

Aspects of the tunable inductor 300-b are not limited thereto, and the first magnetoelectric material 325-a and the second magnetoelectric material 325-b may be coupled to any suitable location on the core 305 such that the AC flux path and DC flux paths described herein pass through the first magnetoelectric material 325-a and second magnetoelectric material 325-b.

For example, in some other embodiments, the first magnetoelectric material 325-a may be coupled to a first upper portion of the core 305 (e.g., between the first leg 301 and the second leg 302), and the second magnetoelectric material 325-b may be coupled to a second upper portion of the core 305 (e.g., also between the first leg 301 and the second leg 302, or between the second leg 302 and the third leg 303). In another example, in some other embodiments, the first magnetoelectric material 325-a may be coupled to a first lower portion of the core 305 (e.g., between the first leg 301 and the second leg 302), and the second magnetoelectric material 325-b may be coupled to a second lower portion of the core 305 (e.g., also between the first leg 301 and the second leg 302, or between the second leg 302 and the third leg 303).

Referring to the example of FIG. 4, a first AC flux path of the plurality of AC flux paths may pass through the first magnetoelectric material 325-a, a second AC flux path of the plurality of AC flux paths may pass through the second magnetoelectric material 325-b, and the DC flux path passes through the first magnetoelectric material 325-a and the second magnetoelectric material 325-b. Accordingly, for example, based on quantity and respective locations of magnetoelectric materials 325, an AC flux path could pass through a single or multiple magnetoelectric materials 325.

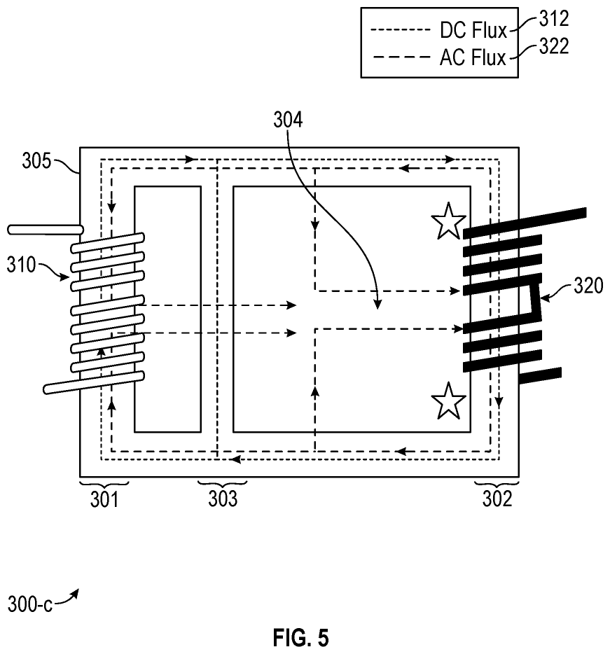

FIG. 5 is an example of a tunable inductor 300-c in accordance with one or more embodiments of the present disclosure.

The tunable inductor 300-c may include aspects of other example tunable inductors (e.g., tunable inductor 300-a, tunable inductor 300-b) described herein, and repeated descriptions of like elements are omitted for brevity. Further, so as not to distract from the additional and/or alternative features described in FIG. 5, aspects of the first controller 311 and AC power source 321 (of FIG. 3) are not illustrated.

According to one or more embodiments of the present disclosure, the tunable inductor 300-c illustrates an example implementation of modifying the geometry of the core 305 supportive of mitigating flux unbalance and eliminating an air gap in tunable inductors (e.g., implementation of a gapless tunable inductor). For example, aspects of the present disclosure support adjusting the placement of the third leg 303 in support of mitigating flux imbalance and implementing the tunable inductor 300-c without an air gap.

Referring to the example of FIG. 5, a first distance between the first leg 301 and the third leg 303 is less than a second distance between the second leg 302 and the third leg 303. Based on the example configuration in FIG. 5, a majority of the AC flux 322 out of the AC winding 320 may return through the space 304 in the window area enclosed by the third leg 303 and the second leg 302, instead of flowing through the DC winding 310. The return of the majority of the AC flux 322 through the space 304 reduces the total AC flux 322 through the winding 310 and the flux imbalance associated with the upper and lower branch of tunable inductor 300-c (e.g., the flux imbalance associated with the flow of the AC flux 322 through the upper branch and lower branch).

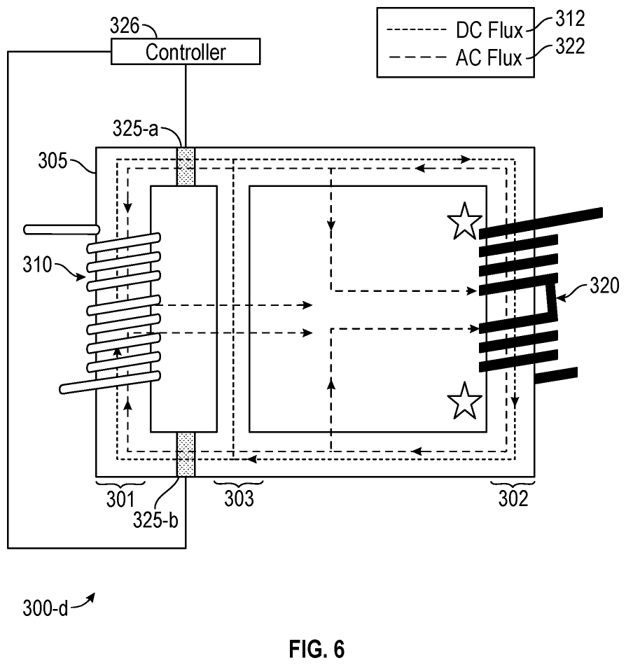

FIG. 6 is an example of a tunable inductor 300-d in accordance with one or more embodiments of the present disclosure. The tunable inductor 300-d may include aspects of other tunable inductors (e.g., tunable inductor 300-a through tunable inductor 300-d) described herein, and repeated descriptions of like elements are omitted for brevity. Further, so as not to distract from the additional and/or alternative features described in FIG. 6, aspects of the first controller 311 and AC power source 321 (of FIG. 3) are not illustrated.

According to one or more embodiments of the present disclosure, the tunable inductor 300-d may include one or more magnetoelectric materials 325 to further balance the AC magnetic flux (e.g., AC flux 322). In the example of FIG. 6, the tunable inductor 300-d includes a first magnetoelectric material 325-a and a second magnetoelectric material 325-d coupled to the core 305.

The tunable inductor 300-d includes a second controller 326 configured to control one or more properties of magnetoelectric materials 325. The second controller 326 may control the properties based on one or more target properties of the tunable inductor 300. In an example, each of the first magnetoelectric material 325-a and the second magnetoelectric material 325-d is coupled to a portion of the core 305 that is not wound by the first winding 310 or the second winding 320.

In the example of FIG. 6, the first magnetoelectric material 325-a is coupled to an upper portion of the core 305, between the first leg 301 and the second leg 302 (e.g., between first leg 301 and third leg 303), and the second magnetoelectric material 325-d is coupled to a lower portion of the core 305 between the first leg 301 and the second leg 302 (e.g., between first leg 301 and third leg 303).

Aspects of the tunable inductor 300-d are not limited thereto, and the first magnetoelectric material 325-a and the second magnetoelectric material 325-d may be coupled to any suitable location on the core 305 such that the AC flux path and DC flux paths described herein pass through the first magnetoelectric material 325-a and second magnetoelectric material 325-d.

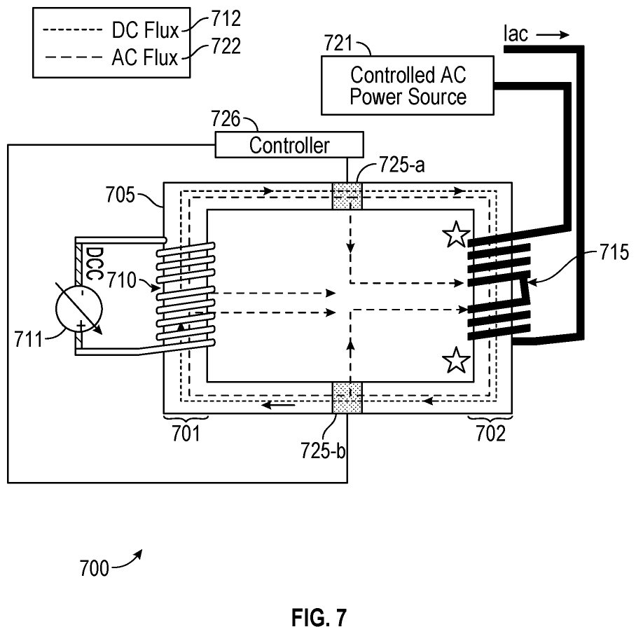

FIG. 7 is an example of a tunable inductor 700 in accordance with one or more embodiments of the present disclosure. The tunable inductor 700 may include aspects of other example tunable inductors (e.g., tunable inductor 100-a, tunable inductor 100-b, tunable inductor 300-a through tunable inductor 300-d) described herein, and repeated descriptions of like elements are omitted for brevity.

According to one or more embodiments of the present disclosure, the tunable inductor 700 illustrates an example implementation using reversely wound windings (e.g., as described with reference to FIGS. 3 through 6) and one or more magnetoelectric materials 725 (e.g., as described with reference to FIGS. 2, 4, and 6) for balancing magnetic flux and eliminating an air gap in tunable inductors (e.g., implementation of a gapless tunable inductor).

The example configuration and features of the tunable inductor 700 described herein further support tunable inductor implementations without central limb (e.g., without third leg 103 of FIGS. 1 and 2, without third leg 303 of FIGS. 3 through 6) and using magnetoelectric materials 725 to balance the flux distribution of the gapless tunable inductors.

According to one or more embodiments of the present disclosure, the tunable inductor 700 includes a core 705 including a first leg 701 and a second leg 702. The tunable inductor 700 includes a first winding 710 wound around the first leg 701 and a second winding 715 wound around the second leg 702. In the example of FIG. 7, winding direction of the upper half of the second winding 715 is opposite to the winding direction of the lower half of the second winding 715. The winding direction of the first winding 710 can be the same as the winding direction of the upper half of the second winding 715 or the winding direction of the lower half of the second winding 715. The core 705 may be an enclosed core of any suitable shape (e.g., a closed shape, quadrilateral, rectangular, square, circular, or the like) or dimension supportive of the techniques of inductor tuning as described herein.

The tunable inductor 700 includes a first magnetoelectric material 725-a coupled to a portion of the core 705 that is not wound by the first winding 710 or the second winding 715. The tunable inductor 700 includes a second magnetoelectric material 725-b coupled to a second portion of the core 705 that is not wound by the first winding 710 or the second winding 715.

The first winding 710 is coupled to controller 711 providing DC power to the first winding 710, and generates a DC flux 712 in a DC flux path (indicated by arrows) in response to the DC power. The DC flux path passes through the first leg 701, the second leg 702, and the magnetoelectric materials 725.

The second winding 715 is coupled to an AC power source 721 providing AC power to the second winding 715 and generates AC flux 722 in a plurality of AC flux paths (indicated by arrows) in response to the AC power. In the example of FIG. 7, a first AC flux path passes through an upper leg (or a portion of the upper leg) of the core 705 and the first magnetoelectric material 725-a and returns via a path perpendicular (e.g., substantially perpendicular or almost perpendicular) to the first leg 701 and the second leg 702. A second AC flux path passes through a lower leg (or a portion of the lower leg) of the core 705 and the second magnetoelectric material 725-b and returns via a second path perpendicular (e.g., substantially perpendicular or almost perpendicular) to the first leg 701 and the second leg 702.

The controller 726 may control properties of magnetoelectric materials 725, for example, based on one or more target properties of the tunable inductor 700 (e.g., reluctance) as described herein. In the example implementation of tunable inductor 700, the tunable inductor 700 is absent an air gap.

As illustrated with respect to the example implementations of FIGS. 2 through 7, the techniques described herein support implementing a tunable inductor (e.g., tunable inductor 100-d, tunable inductor 300), in which the tunable inductor is absent an air gap in a respective core.

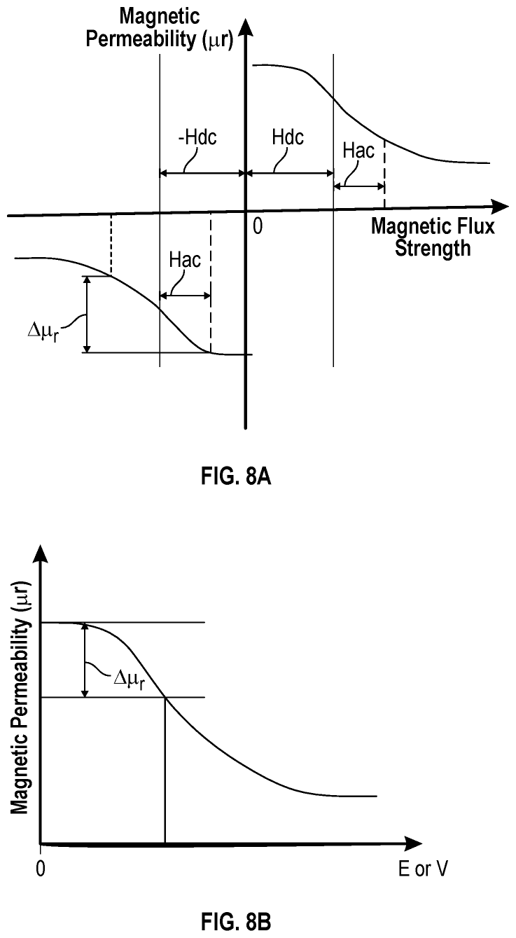

FIGS. 8A and 8B are plots of example characteristics of some other traditional tunable inductors, illustrating the issue of AC flux imbalance. FIG. 8A illustrates an exaggerated representation of a B-H curve associated with some other high power reactors (inductors). In such high power reactors, the change in rated voltage (which is proportional to magnetic permeability (pr) happens around corners of the B-H curve passing the nonlinear region (e.g., where applied AC voltage and Bac is high), and the magnetic permeability μᵣ has relatively large swings in each half AC cycle (corresponding to permeability μᵣ in the two branches of a core where the AC flux flows in opposite directions), leading to a high difference in magnetic permeability fir as illustrated in FIG. 8B. The high difference in magnetic permeability μᵣ causes the imbalance the reluctance R and results in uneven distribution of the AC flux.

As described with reference to at least the example aspects described with reference to FIG. 1, non-limiting examples of advantages and benefits of a tunable inductor in accordance with one or more embodiments of the present disclosure include a reduction in unwanted flux crowding and peak flux saturation in the magnetic core. Some other advantages and benefits include the ability to mitigate the unbalanced flux distribution in the core, which can otherwise cause uncancelled high back-EMF voltage and high ripple current on the DC coil and control path.

As described with reference to at least the example aspects described with reference to FIGS. 2 through 7, non-limiting examples of advantages and benefits of a tunable inductor in accordance with one or more embodiments of the present disclosure include the absence of an air gap in the inductor core, which provides for reduced complexity associated with the fabrication of the magnetic core. Some other advantages and benefits include reduced noise that would otherwise be introduced during operation of an inductor due to air gaps. Some other advantages and benefits include cancelled DC flux on AC coils, cancelled AC flux on a DC coil when not in the B-H nonlinear region, partial or full cancellation of AC flux on a DC coil even when in the B-H nonlinear region (e.g., due to balancing schemes described herein). Some other advantages and benefits include the ability to balance AC flux and achieve full flux cancellation through the implementation and control of magnetoelectric materials as described herein.

Aspects of the embodiments of the tunable inductors described herein are not limited to the example embodiments described herein. Aspects of the present disclosure support one or more suitable combinations of features from one or more embodiments described herein.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the various embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A tunable inductor comprising:
a core having a closed shape and comprising a first leg, a second leg, and a third leg between the first leg and the second leg;
a first winding wound around the first leg;
a second winding wound around the second leg;
a third winding wound around the third leg; and
a first magnetoelectric material coupled to the core,
wherein:
the first winding is coupled to a first controller configured to provide DC power to the first winding, and the first winding is configured to generate a DC flux in a DC flux path in response to the DC power, the DC flux path passing through the first magnetoelectric material;
the second winding is coupled to the first controller and is configured to generate the DC flux in response to the DC power; and
the third winding is coupled to an AC power source configured to provide AC power to the third winding, and the third winding is configured to generate AC flux in an AC flux path in response to the AC power, the AC flux path passing through the first magnetoelectric material.

2. The tunable inductor of claim 1, wherein the first magnetoelectric material is coupled to a portion of the core that is not wound by the first winding, the second winding, or the third winding.

3. The tunable inductor of claim 2, wherein the portion of the core comprises:
an upper portion of the core, wherein the upper portion is between the first leg and the second leg; or
a lower portion of the core, wherein the lower portion is between the first leg and the second leg.

4. The tunable inductor of claim 1, further comprising:
a second magnetoelectric material coupled to the core, wherein:
the DC flux path further passes through the second magnetoelectric material;
the AC flux path further passes through the second magnetoelectric material; and
the second magnetoelectric material is coupled to a portion of the core that is not wound by the first winding, the second winding, or the third winding.

5. The tunable inductor of claim 4, wherein:
the DC flux path passes through the first leg, the second leg, the third leg, the first magnetoelectric material, and the second magnetoelectric material;
the AC flux path passes through the third leg, the first magnetoelectric material, and the first leg in a counterclockwise direction; and
the AC flux path passes through the third leg, the second magnetoelectric material, and the second leg in a clockwise direction.

6. The tunable inductor of claim 1, further comprising:
a second controller configured to control one or more properties of the first magnetoelectric material, wherein the second controller is configured to control the one or more properties based on at least one of:
a reluctance of a first branch of the tunable inductor, the first branch comprising the first leg, the third leg, and a first upper portion between the first leg and the third leg; and
a second reluctance of a second branch of the tunable inductor, the second branch comprising the second leg, the third leg, and a second upper portion between the second leg and the third leg.

7. The tunable inductor of claim 1, wherein the tunable inductor is absent an air gap.

8. A tunable inductor comprising:
a core having a closed shape and comprising a first leg, a second leg, and a third leg between the first leg and the second leg;
a first winding wound around the first leg; and
a second winding wound around the second leg, wherein a first winding direction of an upper half of the second winding is opposite to a second winding direction of a lower half of the second winding,
wherein:
the first winding is coupled to a controller configured to provide DC power to the first winding, and the first winding is configured to generate a DC flux in a DC flux path in response to the DC power, the DC flux path passing through the first leg, the third leg, and the second leg; and
the second winding is coupled to an AC power source configured to provide AC power to the second winding, and the second winding is configured to generate AC flux in a plurality of AC flux paths in response to the AC power, wherein:
a first AC flux path of the plurality of AC flux paths passes through an upper portion of the core and returns via a path perpendicular to the third leg; and
a second AC flux path of the plurality of AC flux paths passes through a lower portion of the core and returns via a second path perpendicular to the third leg.

9. The tunable inductor of claim 8, further comprising:
a first magnetoelectric material coupled to a portion of the core that is not wound by the first winding or the second winding, wherein:
the DC flux path passes through the first magnetoelectric material; and
the first AC flux path passes through the first magnetoelectric material.

10. The tunable inductor of claim 9, wherein the portion of the core comprises:
the upper portion of the core, wherein the upper portion is between the first leg and the second leg; or
the lower portion of the core, wherein the lower portion is between the first leg and the second leg.

11. The tunable inductor of claim 9, further comprising:
a second magnetoelectric material coupled to a second portion of the core that is not wound by the first winding or the second winding, wherein:
the DC flux path further passes through the second magnetoelectric material; and
the first AC flux path or the second AC flux path passes through the second magnetoelectric material.

12. The tunable inductor of claim 8, wherein:
a first distance between the first leg and the third leg is less than a second distance between the second leg and the third leg.

13. The tunable inductor of claim 8, further comprising:
a controller configured to control one or more properties of one or more magnetoelectric materials coupled to portion of the core that is not wound by the first winding or the second winding, wherein the controller is configured to control the one or more properties based on one or more target properties of the tunable inductor.

14. The tunable inductor of claim 8, wherein the tunable inductor is absent an air gap.

15. A tunable inductor comprising:
a core having a closed shape and comprising a first leg and a second leg;
a first winding wound around the first leg; and
a second winding wound around the second leg, wherein a first winding direction of an upper half of the second winding is opposite to a second winding direction of a lower half of the second winding,
wherein:
the first winding is coupled to a controller configured to provide DC power to the first winding, and the first winding is configured to generate a DC flux in a DC flux path in response to the DC power, the DC flux path passing through the first leg and the second leg; and
the second winding is coupled to an AC power source configured to provide AC power to the second winding, and the second winding is configured to generate AC flux in a plurality of AC flux paths in response to the AC power, wherein:
a first AC flux path of the plurality of AC flux paths passes through an upper leg of the core and returns via a path perpendicular or almost perpendicular to the first leg and the second leg; and
a second AC flux path of the plurality of AC flux paths passes through a lower leg of the core and returns via a second path perpendicular or almost perpendicular to the first leg and the second leg.

16. The tunable inductor of claim 15, further comprising:
a first magnetoelectric material coupled to a portion of the core that is not wound by the first winding or the second winding, wherein:
the DC flux path passes through the first magnetoelectric material; and
the first AC flux path passes through the first magnetoelectric material.

17. The tunable inductor of claim 16, wherein the portion of the core comprises:
an upper portion of the core, wherein the upper portion is between the first leg and the second leg; or
a lower portion of the core, wherein the lower portion is between the first leg and the second leg.

18. The tunable inductor of claim 16, further comprising:
a second magnetoelectric material coupled to a second portion of the core that is not wound by the first winding or the second winding, wherein:
the DC flux path further passes through the second magnetoelectric material; and
the first AC flux path or the second AC flux path passes through the second magnetoelectric material.

19. The tunable inductor of claim 16, further comprising:
a controller configured to control one or more properties of one or more magnetoelectric materials coupled to portion of the core that is not wound by the first winding or the second winding, wherein the controller is configured to control the one or more properties based on one or more target properties of the tunable inductor.

20. The tunable inductor of claim 15, wherein the tunable inductor is absent an air gap.
